(19) United States
(12) Patent Application Publication
(10) Pub. No.: US 2010/0119080 A1
(43) Pub. Date: May 13, 2010

(54) HUMAN BODY SOUND TRANSMISSION SYSTEM AND METHOD USING SINGLE SOUND SOURCE

(75) Inventors: Sung-Eun Kim, Seoul (KR); Chang-Hee Hyoung, Daejon (KR); Jin-Kyung Kim, Daejon (KR); Duck-Gun Park, Daejon (KR); Hyung-Il Park, Daejon (KR); In-Gi Lim, Daejon (KR); Jung-Bum Kim, Daejon (KR); Kyung-Soo Kim, Daejon (KR); Sung-Weon Kang, Daejon (KR); Jung-Hwan Hwang, Daejon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Instit ute, Daejon (KR)

(21) Appl. No.: 12/598,471

(22) PCT Filed: Mar. 25, 2008
(86) PCT No.: PCT/KR08/01667

§ 371 Date: Nov. 2, 2009

(30) Foreign Application Priority Data
May 2, 2007 (KR) 10-2007-0042677

(51) Int. Cl. H04R 1/40; H04R 25/00

(52) U.S. Cl. 381/97; 381/151

(57) ABSTRACT

Provided are a human body sound transmission system and a method using single sound source. The human body sound transmission system includes a first transmission block for transmitting a combined signal of a first high frequency signal and a sound signal through a human body; and a second transmission block for transmitting a second high frequency signal having the same frequency as the first high frequency signal through the human body, to thereby recover the sound signal by destructing interference in a ear region of a user.

### TECHNICAL FIELD

The present invention relates to a human body sound transmission system using a human body as a transmission channel and a method thereof; and, more particularly, to a human body sound transmission system and method using a single sound source which can make users listen without a separate reception apparatus, simplify a sound system structure, and reduce cost of the sound system by transmitting a first high frequency signal carrying a sound signal in one transmission apparatus, transmitting a second high frequency signal having the same frequency as the first high frequency signal in the other transmission apparatus, and recovering the sound signal by a destructive interference between the first high frequency signal and the second high frequency signal in ear region of a user.

This work was supported by the Information Technology (IT) research and development program of the Korean Ministry of Information and Communication (MIC) and the Korean Institute for Information Technology Advancement (IITA) [2006-S-072-01, “Controller SoC for Human Body Communications”].

### BACKGROUND ART

A “Human body communication” eliminates ‘line’ of electrical appliances based on a principle that an electrical signal flows through a human body, and transmits a signal through changing electrical energy of the signal by using the human body as a cable.

A “Sound transmission system” disclosed in U.S. publication No. 2006/0143004 published in Jun. 29, 2006, which was filed claiming priority of the KR Patent Application Nos. 10-2004-0103036 and 10-2005-0100624, suggests a high frequency sound transmission system using the human body as the communication channel. In the high frequency sound transmission system, each of two sound transmission apparatuses has a corresponding sound source.

That is, in the above conventional sound transmission system, each sound transmission apparatus generates a sound signal, combines the generated sound signal and a high frequency signal, and transmits the combined signal through the human body. However, since each transmission apparatus includes the sound source, a structure of the conventional sound transmission system is complex, and thus manufacturing cost is expensive.

### DISCLOSURE OF INVENTION

### Technical Problem

An embodiment of the present invention is directed to provide a human body sound transmission system and method using a single sound source which can make users listen without a separate reception apparatus, simplify a sound system structure, and reduce manufacturing cost by transmitting a first high frequency signal carrying a sound signal in one transmission apparatus, transmitting a second high frequency signal having the same frequency as the first high frequency signal in other transmission apparatus, and recovering the sound signal by a destructive interference between the first high frequency signal and the second high frequency signal in ear region of a user.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a human body sound transmission system, including: a first transmission block for transmitting a combined signal of a first high frequency signal and a sound signal through a human body; and a second transmission block for transmitting a second high frequency signal having the same frequency as the first high frequency signal through the human body, to thereby recover the sound signal by destructing interference in a ear region of a user.

In accordance with another aspect of the present invention, there is provided a human body sound transmission method using a single sound source, comprising: transmitting a first high frequency signal carrying a sound signal through a human body; and transmitting a second high frequency signal having the same frequency as the first high frequency signal through the human body, to thereby recover the sound signal by destructive interference between the first high frequency signal and the second high frequency signal in a ear region of a user.

### ADVANTAGEOUS EFFECTS

In the above present invention, since a human body sound transmission system includes a single sound source, it can be easily implemented. Also, a user contacted to a transmission apparatus can listen to a transmitted sound signal without a separate reception apparatus.

In addition, the human body sound transmission system can make only the user doing a human body communication to receive transmitted sound signal. The user can receive the sound signal without the separate reception apparatus, and thus, behaviors of the user may be free.

### BRIEF DESCRIPTION OF THE DRAWINGS

FIG. 1 is a diagram illustrating a human body sound transmission system in accordance with an embodiment of the present invention.

FIG. 2 is a block diagram illustrating a first transmission apparatus having a sound source in accordance with an embodiment of the present invention.

FIG. 3 is a block diagram illustrating a second transmission apparatus without a sound source in accordance with an embodiment of the present invention.

FIGS. 4 to 8 are waveforms showing a destructive interference and a constructive interference between two signals transmitted from a human body sound transmission system in accordance with the present invention.

### BEST MODE FOR CARRYING OUT THE INVENTION

The advantages, features and aspects of the invention will become apparent from the following description of the embodiments with reference to the accompanying drawings, which is set forth hereinafter, and thus the invention will be easily carried out by those skilled in the art to which the invention pertains. Also, when it is considered that detailed description on a related art may obscure the points of the present invention unnecessarily in describing the present invention, the description will not be provided herein. Hereinafter, specific embodiments of the present invention will be described with reference to the accompanying drawings.

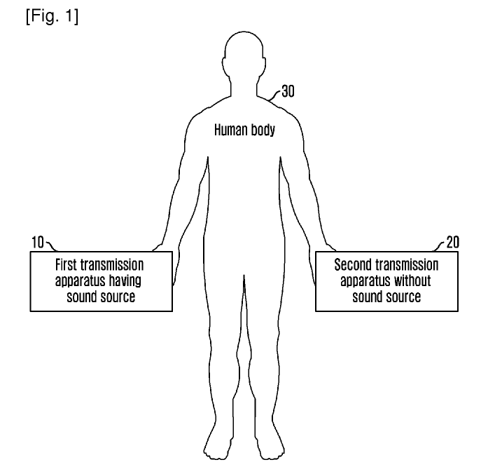

FIG. 1 is a diagram illustrating a human body sound transmission system in accordance with an embodiment of the present invention. Hereinafter, a human body sound transmission method using a single sound source in accordance with the present invention will be described together without an additional flowchart.

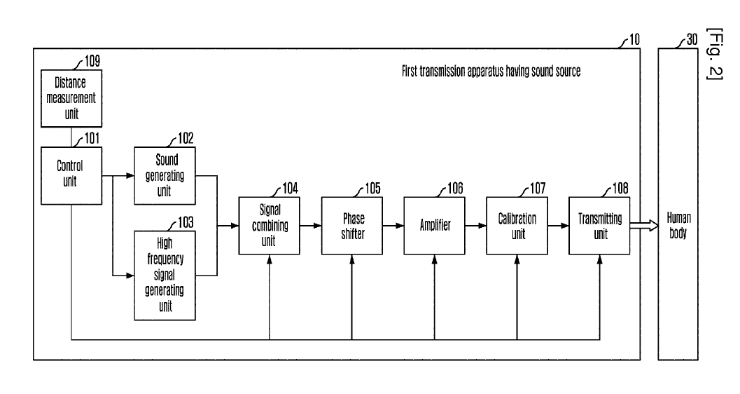

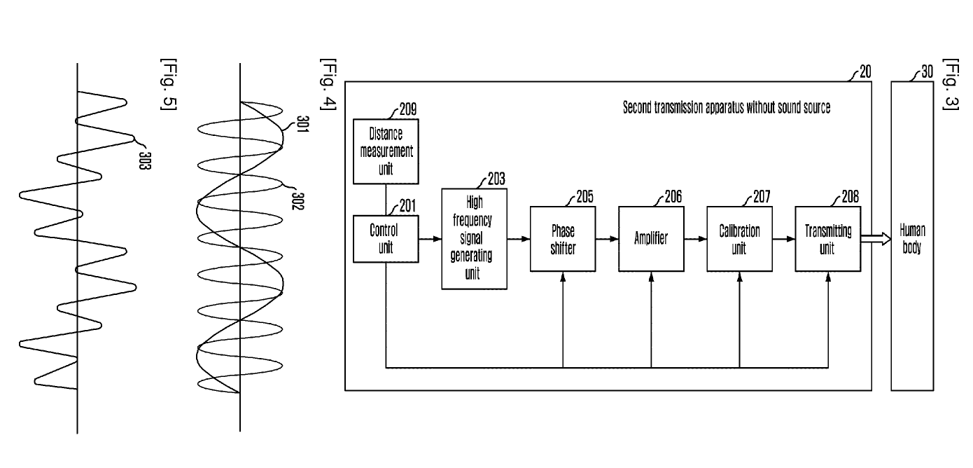

As shown in FIG. 1, the human body sound transmission system includes a first transmission apparatus 10 and a second transmission apparatus 20 directly connected to the human body 30. The first and second transmission apparatuses 10 and 20 are contacted to the human body apart from the same distance from each ear, respectively. Here, the first transmission apparatus 10 has a sound source, and the second transmission apparatus 20 has no sound source. Detailed description will be described referring to FIGS. 2 and 3.

A user can directly receive only sound signals based on a destructive interference between signals transmitted from each transmission apparatuses 10 and 20 without data processing for demodulating signals transmitted through the human body 30 as a communication signal.

The first transmission apparatus 10 generates a combined signal by combining the sound signal and a first high frequency signal, and transmits the combined signal through the human body 30. Also, the second transmission apparatus 20 generates the second high frequency signal having the same frequency as the first high frequency signal generated in the first transmission apparatus 10 and transmits the second high frequency signal through the human body 30.

In the ear region of the user, the destructive interference and a constructive interference occur by overlapping two signals transmitted from each of transmission apparatuses 10 and 20. Since a signal generated by the constructive interference is over an audio frequency band of human, the user cannot detect the signal. Hereinafter, only the destructive interference will be described.

FIG. 2 is a block diagram illustrating a first transmission apparatus having a sound source in accordance with an embodiment of the present invention; and FIG. 3 is a block diagram illustrating a second transmission apparatus without a sound source in accordance with an embodiment of the present invention.

As shown in FIG. 2, the first transmission apparatus 10 having the sound source includes a control unit 101, a sound generating unit 102, a high frequency signal generating unit 103, a signal combining unit 104, a phase shifter 105, an amplifier 106, a calibration unit 107, a transmitting unit 108 and a distance measurement unit 109. Herein, the first transmission apparatus 10 may be a hand-held type.

On the contrary, as shown in FIG. 3, the second transmission apparatus 20 without the sound source includes a control unit 201, a high frequency signal generating unit 203, a phase shifter 205, an amplifier 206, a calibration unit 207, a transmitting unit 208 and a distance measurement unit 209. Herein, the second transmission apparatus 20 may be the hand-held type.

The first transmission apparatus 10 transmits the sound signal though the human body 30.

The control units 101 and 201 receive distances between the ear and the first and second transmission apparatuses 10 and 20, respectively, and adjust frequency and phase of the signal generated in the sound generating unit 102 and the high frequency signal generating units 103 and 203. That is, the control unit 101 eliminates the high frequency signal included in the combined signal outputted from the first transmission apparatus 10 by the destructive interference in the ear region, allows only sound signals of audio frequency band to be transmitted to the ear of the human, and thus the user can listen sound signals without the separate reception apparatus.

The control unit 101 of the first transmission apparatus 10 contacted to the human body 30 sets the frequency of the high frequency signal identically to that of a output signal from the second transmission apparatus 20 based on a distance from the ear to the transmission apparatus and a distance from other transmission apparatus 20 contacted to the same human body 30. The control unit 201 is operated identically to the control unit 101. When the two transmission apparatuses 10 and 20 are symmetrically contacted to the human body 30 with the same distance from the each ear, the control units 101 and 201 control the frequency and the phase of the corresponding high frequency signal transmitted through the human body in order to have the same frequency and phase.

In other words, the control units 101 and 102 adjust frequencies of output signals generated in the sound generating unit 102 and the high frequency signal generating units 103 and 203, respectively, to recover only sound signal of audio frequency band based on destructive of the high frequency signals by overlapping of signals outputted from the first and second transmission apparatuses 10 and 20 around the ears. Here, the control units 101 and 201 of the two transmission apparatuses 10 and 20 can control a occurrence part and occurrence time of the destructive interference in the human body 30 by adjusting output speed of signals outputted from the high frequency signal generating units 103 and 203 and the transmitting units 108 and 109 so that a stereophonic sound effect can be provided.

Also, the control units 101 and 201 can change phases of output signals by controlling the phase shifters 105 and 205, respectively, and adjust phases and frequencies of output signals by considering impedance matching between the human body 30 and the transmission apparatuses 10 and 20. In addition, the control units 101 and 201 transmit pre-stored clock information and impedance matching information of the human body 30 to the calibration units 107 and 207, respectively, and thus the clock information and the impedance matching information are used to calibrate transmitted signals through the human body 30.

When the clock information and the impedance matching information of the human body 30 are stored in a separate memory of the transmission apparatuses 10 and 20, the control units 101 and 201 extract the clock information and the impedance matching information from the corresponding memory and transmit them to the calibration units 107 and 207, respectively, and thus the clock information and the impedance matching information can be used to calibrate transmitted signals through the human body 30.

The sound generating unit 102 of the first transmission apparatus 10 having the sound source extracts sound data from the memory according to the control signal of the control unit 101, and generates sound signals of audio frequency band corresponding to the extracted sound data in order to transmit the sound signals through the human body 30. The sound generating unit 102 generates the sound signals based on the sound data stored in the memory of the first transmission apparatus 10, or generates the sound signals by receiving sound data from an outer communication apparatus.

Then, the high frequency signal generating unit 103 of the first transmission apparatus 10 generates a first high frequency signal to be combined and transmitted with the sound signal outputted from the sound generating unit 102.

The high frequency signal generating unit 203 of the second transmission apparatus 20 generates a second high frequency signal having the same phase with the first high frequency signal transmitted from the first transmission apparatus 10. When the phases of two high frequency signals outputted form the transmission apparatuses 10 and 20 are identical to each other, the phases of the two high frequency signals, i.e., one is a simple high frequency signal and the other is a high frequency signal carrying the sound signal, become out-of phase in the ear region, and thus two high frequency signals are canceled.

The frequency of the high frequency signals generated in the high frequency signal generating units 103 and 203 can vary according to the frequency of the sound signal and the impedance of the human body 30.

High frequency signals generated in the two transmission apparatuses 10 and 20 are controlled to have the same phase in order to be canceled by the destructive interference in the ear region of the human body 30. The signals outputted from the high frequency signal generating units 103 and 203 can be ultrasonic signals having a higher frequency than that of the audio frequency band, i.e., 20 Hz to 20,000 Hz.

The sound signal generated in the sound generating unit 102 of the first transmission apparatus 10 and the high frequency signal generated in the high frequency signal generating unit 103 are combined in the signal combining unit 104, and the combined signal is transmitted through the human body. The signal combining unit 104 combines the sound signal and the high frequency signal in order to minimize attenuation of sound wave during transmission of the sound signal through the human body 30 due to the impedance characteristics of the human body.

The phase shifter 105 of the first transmission apparatus 10 changes the output phase of the combined signal outputted from the signal combining unit 104 according to the control signal of the control unit 101. Also, the phase shifter 205 of the second transmission apparatus 20 changes the phase of the second high frequency signal outputted from the high frequency signal generating unit 203 according to the control signal of the control unit 201.

The phase shifter 105 adjusts the phase of the signal outputted from the first transmission apparatus 10. Also, the phase shifter 205 adjusts the phase of the signal outputted from the second transmission apparatus 20. Accordingly, the high frequency signals are canceled when the two high frequency signals are overlapped. When the first distance between the first transmission apparatus 10 contacted to the right side of the human body 30 and the right ear is extremely different from the second distance between the second transmission apparatus 20 contacted to the left side of the human body 30 and the left ear, the phase shifters 105 and 205 adjust the phases of two signals by delaying one of the signals in order that two signals are overlapped and interference occurs in the head of the human body 30.

In addition, the phase shifter 105 changes the phase of the signal outputted from the first transmission apparatus 10 by controlling delay so that an interference occurrence part of the human body 30 is controlled. Likely, the phase shifter 205 changes the phase of the signal outputted from the second transmission apparatus 20 by controlling delay, so that the interference occurrence part of the human body 30 is controlled.

The phase shifters 105 and 205 can change the phase of signal based on a general phase shifting method, e.g., an electrical method or a mechanical method, such as a phase shifting method through a line switching.

The amplifiers 106 and 206 amplify output level of the phase shifted signals of the two transmission apparatuses in order to prevent attenuation of signals due to added noise during transmission through the human body 30.

Since the control units 101 controls amplification ratio of the amplifier 106 and the control units 201 controls amplification ratio of the amplifier 206, flexible handling can be achieved due to communication channel environment variation according to skin condition and health condition of the user.

In the first transmission apparatus 10 transmitting the combined signal of the sound signal and the high frequency signal, the calibration unit 107 solves sound quality problem i.e., difficult problem of controlling the sound quality, due to signal distortion. The signal distortion is caused by the impedance characteristics of the human body 30. Since the impedance characteristics of the human body is varied according to the change of contact portions of transmission apparatuses 10 and 20, and variation of health condition, the calibration considering the impedance characteristics should to be performed.

The transmitting units 108 and 208 are directly contacted to the human body 30 in the transmission apparatuses 10 and 20, and output the combined signal of the sound signal and the high frequency signal, or the high frequency signal, respectively. The transmitting units 108 and 208 perform acoustically coupling between the transmission apparatuses 10 and 20, and the human body 30. That is, each of the transmitting units 108 and 208 is a kind of transducer, and transforms and outputs the signal to a vibration signal or an electrical signal which can be transmitted and recovered in the human body.

As shown in FIG. 2, the calibration unit 107 is located after the amplifier 106 in the first transmission apparatus 10, and improves frequency characteristic and input/output characteristics by correcting the combined signal outputted from the signal combining unit 104. However, in another embodiment, the calibration unit 107 may be located before the signal combining unit 104, and can correct input signals before being combined.

Also, the transmission apparatuses 10 and 20 in accordance with the present invention may additionally include the distance measurement units 109 and 209 which measure distances between the contact portion corresponding to each transmission apparatus 10 or 20 and right ear or left ear based on sensing function. Then, the control units 101 and 201 control the phase shifters 105 and 205 based on the distances measured in the measurement units 109 and 209 to recover only the sound signal through destructive interference in the ear region of the user.

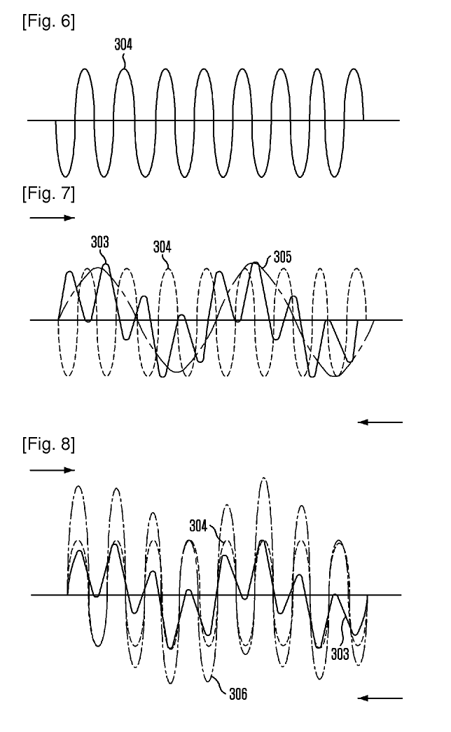

FIGS. 4 to 8 are waveforms showing a destructive interference and a constructive interference between two signals transmitted from a human body sound transmission system in accordance with the present invention. Hereinafter, transmission of the sound signal in the human body sound transmission system will be described referring to FIGS. 4 to 8.

FIGS. 5 and 6 represent waveforms of two signals transmitted from the transmission apparatuses 10 and 20; FIG. 7 represents waveform showing the destructive interference between the two signals; and FIG. 8 represents waveform showing the constructive interference between the two signals.

FIG. 4 shows waveforms of a sound signal 301 and a first high frequency signal 302 generated in the first transmission apparatus 10 contacted to the human body 30; FIG. 5 shows waveform representing a signal 303 generated in the signal combining unit 104 by combining the sound signal 301 and the first high frequency signal 302. Also, FIG. 6 shows waveform of a second high frequency signal 304 generated in the second transmission apparatus 20 contacted to the same human body 30.

The second high frequency signal 304 shown in FIG. 6 precedes half-period than the first high frequency signal 302 shown in FIG. 4. That is, the first high frequency signal 302 and the second high frequency signal are out-of phase.

FIG. 7 shows waveform 305 generated by the destructive interference between the two signals 303 and 304, which are outputted from the first transmission apparatus 10 and the second transmission apparatus 20 and have different phases to each other; and FIG. 8 shows waveform 306 generated by the constructive interference between the two signals 303 and 304.

When the destructive interference occurs as shown in FIG. 7, the high frequency signals are canceled, and the sound signal is transmitted into the ear region. On the other hand, when the constructive interference occurs as shown in FIG. 8, since the high frequency signal, which is higher than the audio frequency band of the human, still remains, user cannot detect the signal generated by the constructive interference. That is, only a signal generated by the destructive interference can be effectively transmitted through the human body, and can be detected by the user.

While the signals outputted from the two transmission apparatuses 10 and 20 are continuously transmitted through the medium of the human body, parts of the constructive interference change into the destructive interference, parts of the destructive interference change into the constructive interference in signal transmission. Thus, the sound signal can be detected in all regions overlaying two high frequency signals.

As described above, the present invention induces the destructive interference in the ear region by adjusting phases of the high frequency signals. However, the control unit 101 makes only the sound signal to arrive in the ear region of the human body by controlling frequencies of the sound signal outputted from the sound generating unit 102 and the high frequency signal outputted from the high frequency signal generating unit 103.

For example, in case that the sound signal to be transmitted has f₀ frequency, the control unit 101 controls the sound generating unit 102 to generate the sound signal having f₀ frequency and the high frequency generating unit 103 to generate the high frequency signal having f₁ frequency. Also, the control unit 201 controls the high frequency generating unit 203 to generate the high frequency signal having f₁ frequency. Finally, the first transmission apparatus 10 outputs the signal having f₀+f₁ frequency, and the second transmission apparatus 20 outputs the signal having f₁ frequency.

The output signals are combined into a signal having f₀ frequency in the ear region, and the signal is transmitted through the human body. As described above, if the sound signal having a predetermined frequency can be acquired by combining the signals outputted from the two transmission apparatuses 10 and 20 contacted to the human body 30, any combination of all frequencies can be used.

The above described method according to the present invention can be embodied as a program and be stored on a computer readable recording medium. The computer readable recording medium is any data storage device that can store data which can be read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application No. 2007-0042677, filed in the Korean Intellectual Property Office on May 2, 2007, the entire contents of which are incorporated herein by reference.

While the present invention has been described with respect to certain preferred embodiments, it will be apparent to those skilled in the art that various changes and modifications may be made without departing from the scope of the invention as defined in the following claims.

1. A human body sound transmission system, comprising:
a first transmission means for transmitting a combined signal of a first high frequency signal and a sound signal through a human body; and
a second transmission means for transmitting a second high frequency signal having the same frequency as the first high frequency signal through the human body, to thereby recover the sound signal by destructing interference in a ear region of a user.

2. The human body sound transmission system of claim 1, wherein the first transmission means includes:
a sound generating unit for generating the sound signal based on sound data;
a first high frequency signal generating unit for generating the first high frequency signal carrying the sound signal;
a signal combining unit for combining the sound signal and the first high frequency signal and outputting the combined signal;
a first phase shifter for shifting a phase of the combined signal, to thereby recover the sound signal by the destructive interference between the first high frequency signal and the second high frequency signal in the ear region of the user;
a first control unit for adjusting frequencies of the sound signal and the first high frequency signal and controlling signal combination in the signal combining unit and phase shifting in the first phase shifter; and
a first transmission unit for outputting the phase shifted combined signal to the human body.

3. The human body sound transmission system of claim 2, wherein the first transmission means further includes:
a first amplifier for amplifying the combined signal to prevent signal attenuation due to noise which occurs in human body transmission.

4. The human body sound transmission system of claim 2, wherein the first transmission means further includes:
a first calibration unit for compensating distortion of the combined signal according to variation of impedance characteristic of the human body.

5. The human body sound transmission system of claim 2, wherein the sound generating unit generates the sound signal based on the sound data stored in an inner memory or sound data received from an outer communication apparatus.

6. The human body sound transmission system of claim 1, wherein the second transmission means includes:
a second high frequency signal generating unit for generating the second high frequency signal having the same frequency as the first high frequency signal;
a second phase shifter for shifting a phase of the second high frequency signal to recover the sound signal by the destructive interference between the first high frequency signal and the second high frequency signal in the ear region of the user;
a second control unit for adjusting frequency of the second high frequency signal and controlling phase shifting in the second phase shifter; and
a second transmission unit for outputting the phase shifted second high frequency signal to the human body.

7. The human body sound transmission system of claim 6, wherein the second transmission means further includes:
a second amplifier for amplifying the second high frequency signal to prevent signal attenuation due to noise which occurs in human body transmission.

8. The human body sound transmission system of claim 6, wherein the second transmission means further includes:
a second calibration unit for compensating distortion of the second high frequency signal according to variation of impedance characteristic of the human body.

9. The human body sound transmission system of claim 6, wherein the sound signal is an audio frequency band signal which can be transmitted through the human body and the first and second high frequency signals are high frequency signals having higher frequency than the audio frequency band.

10. The human body sound transmission system of claim 9, wherein the first and second high frequency signals are high frequency signals having higher frequency than the audio frequency band.

11. The human body sound transmission system of claim 6, the first and second transmission means are contacted to human body of the user and depart from the same distance from right ear and left ear of the user, respectively.

12. The human body sound transmission system of claim 11, wherein the first and second control units control the first and the second phase shifters in such a manner that a phase of the combined signal outputted from the first transmission means is the same as a phase of the second high frequency signal outputted from the second transmission means.

13. The human body sound transmission system of claim 6, wherein each of the first transmission means and the second transmission means further includes:
a distance measurement unit for measuring distance between right/left ear and a human body contact portion of a corresponding transmission means; and
wherein the first control unit and the second control unit control the first phase shifter and the second phase shifter, respectively, based on the measured distance to recover the sound signal by the destructive interference in the ear region of the user.

14. A human body sound transmission method using a single sound source, comprising:
transmitting a first high frequency signal carrying a sound signal through a human body; and
transmitting a second high frequency signal having the same frequency as the first high frequency signal through the human body, to thereby recover the sound signal by destructive interference between the first high frequency signal and the second high frequency signal in a ear region of a user.

15. The human body sound transmission method of claim 14, wherein the transmitting the first high frequency signal includes:
generating the sound signal based on sound data;
generating the first high frequency signal to carry the sound signal;
generating a combined signal by combining the sound signal and the first high frequency signal;
shifting a phase of the combined signal to recover the sound signal by the destructive interference between the first high frequency signal and the second high frequency signal in the ear region of the user; and
transmitting the phase shifted combined signal through the human body.

16. The human body sound transmission method of claim 14, wherein the transmitting the first high frequency signal further includes:
amplifying the combined signal to prevent signal attenuation due to noise which occurs in human body transmission.

17. The human body sound transmission method of claim 14, wherein the transmitting the sound signal further includes:
compensating distortion of the combined signal according to variation of impedance characteristic of the human body.

18. The human body sound transmission method of claim 14, wherein the transmitting the second high frequency signal includes:
generating the second high frequency signal having the same frequency as the first high frequency signal;
shifting a phase of the second high frequency signal to recover the sound signal by the destructive interference between the first high frequency signal and the second high frequency signal in the ear region of the user; and
transmitting the phase shifted second high frequency signal through the human body.

19. The human body sound transmission method of claim 18, wherein the transmitting the second high frequency signal further includes:
amplifying the second high frequency signal to prevent signal attenuation due to noise which occurs in human body transmission.

20. The human body sound transmission method of claim 18, wherein the transmitting the second high frequency signal further includes:
compensating distortion of the second high frequency signal according to variation of impedance characteristic of the human body.
